(19) United States
(12) Patent Application Publication
(10) Pub. No.: US 2026/0368748 A1
(43) Pub. Date: Nov. 19, 2026

(54) IN-TRANSIT REFUND ANALYSIS FOR AN IN-TRANSIT SERVICE OF A TRANSPORT CRAFT

(71) Applicant: VIASAT, INC., Carlsbad, CA (US)

(72) Inventors: Gregory R. JAY, San Diego, CA (US); Joshua G. SLATER, Rancho Mission Viejo, CA (US); Shashanka RAO, San Jose, CA (US); Andrew D. TIRELLA, Groton, MA (US)

(21) Appl. No.: 19/130,880

(22) PCT Filed: Nov. 15, 2023
(86) PCT No.: PCT/US2023/079882

§ 371 Date: May 16, 2025

Related U.S. Application Data
(60) Provisional application No. 63/384,187, filed on Nov. 17, 2022.

(51) Int. Cl. G06Q 30/015; G06Q 10/0639; H04L 41/50

(52) U.S. Cl. CPC G06Q 30/015; G06Q 10/06398; H04L 41/50

(57) ABSTRACT

Determination of whether to issue a refund to passengers having purchased an in-transit service based on actual performance of the service over an elapsed portion of the trip and projected performance over a remaining portion of the trip. Because the determination is performed during the trip, a determination that a total trip performance metric, based on actual and projected performance, does not or cannot satisfy a performance criteria may allow a refund to be issued during the trip (e.g. before arrival at a destination). In one example, the projected performance of the service includes ideal performance such that a refund may be issued before arrival when the total trip performance metric cannot satisfy the performance criterion.

### CROSS REFERENCE TO RELATED APPLICATIONS

This application claims priority to U.S. Provisional Application No. 63/384,187 filed on Nov. 17, 2022, and entitled “SYSTEMS AND METHODS FOR REAL TIME IN-TRANSPORT REFUND ANALYSIS,” the entirety of which is incorporated by reference.

### BACKGROUND

In-transit services provided to passengers of a transport craft have become common. An example of an in-transit service includes a communication service that allows passengers to exchange data with off-board network destinations during the course of a trip on the transport craft. In many examples, passengers may purchase access to such a service for a given trip. Accordingly, these passengers generally expect a certain level of service for their purchase.

When passengers experience an undesirable level of service, they are often motivated to contact the service provider or transport provider to report the undesirable level of service and request a refund of the payment for the in-transit service. To help ensure a desirable experience for their customers, service and transport providers typically encourage their customers to report issues and work to address those issues promptly. Contacting customer support may often present frustrations for customers that degrade the overall impression of the in-transit service offered on the transport craft and the transportation operator of the craft more generally.

### SUMMARY

In some aspects, the techniques described herein relate to a method for refunding a passenger for an in-transit service on a transport craft based on performance of the in-transit service, including: measuring actual performance of the in-transit service provided on the transport craft during an elapsed portion of a trip of the transport craft between an origin and a destination; determining a projected trip duration including the elapsed portion of the trip and a remaining portion of the trip; projecting a future performance of the in-transit service for the remaining portion of the trip; generating a total trip performance metric for the in-transit service based on the actual performance and the future performance; comparing the total trip performance metric to a performance criterion for the trip; and generating a refund for the in-transit service in response to the total trip performance metric not satisfying the performance criterion.

In some aspects, the techniques described herein relate to a system for refunding a passenger for an in-transit service on a transport craft based on performance of the in-transit service, including: a performance monitor operative to measure actual performance of the in-transit service provided on the transport craft during an elapsed portion of a trip of the transport craft between an origin and a destination; a trip modeler operative to: determine a projected trip duration including the elapsed portion of the trip and a remaining portion of the trip project a future performance of the in-transit service for the remaining portion of the trip, and generate a total trip performance metric for the in-transit service based on the actual performance and the future performance; and a service evaluation module operative to compare the total trip performance metric to a performance criterion for the trip and generate a refund for the in-transit service in response to the total trip performance metric failing to satisfy the performance criterion.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example of a satellite communication system that provides an in-transit service, namely an in-transit data communication service, according to the present disclosure.

FIG. 2 illustrates a schematic view of an example communication system for delivering an in-transport communication service with components disposed at a provider-side and transport craft-side of a provider network.

FIG. 3 illustrates an example of a trip between a departure location and a destination location for which a projected trip duration may be determined.

FIG. 4 illustrates an example scenario in which projected future performance of an in-transit service is illustrated.

FIGS. 5-6 illustrate example scenarios in which ideal projected future performance of an in-transit service is used to determine if a performance criterion can be met.

FIG. 7 illustrates an example process for refunding a passenger for an in-transit service on a transport craft based on the actual and projected performance of the in-transit service.

### DETAILED DESCRIPTION

While the invention is susceptible to various modifications and alternative forms, specific embodiments have been shown by example in the drawings and are herein described in detail. It should be understood, however, that it is not intended to limit the invention to the particular form disclosed, but rather, the invention is to cover all modifications, equivalents, and alternatives falling within the scope of the invention as defined by the claims.

As recognized above, an in-transit service purchased by a passenger preferably meets certain standards for performance. Otherwise, the paying passenger may become dissatisfied with the in-transit service and/or the transportation operator. While traditional approaches to customer support may allow a passenger to report unsatisfactory service and obtain a refund, such systems are often not user-friendly, require the passenger to expend their time and effort, and may engender even further ill will in the passenger's mind.

Accordingly, the present disclosure relates to approaches that may process a refund to one or more passenger that has purchased an in-transit service based, at least in part, on a projected future performance of the service for a trip. As such, it may be determined during the trip of the transport craft from an origin to a destination that the in-transit service fails, or will fail, to meet a performance criterion established for the service. In this regard, a refund may be issued to passengers having purchased the in-transit service before arrival at the destination (e.g., before departing the transport craft). In turn, a paying passenger may avoid the time and complications associated with contacting customer service in the event of unsatisfactory performance of the in-transit service. Customer goodwill may be fostered, and future purchases of in-transit services may be increased.

An in-transit service may be provided to passengers by a transportation provider, such as an airline, bus line, cruise line, train line, etc. The transportation provider may desire to provide a positive experience to its passengers for the in-transit service, such as an in-transit communication service. To engender a positive passenger experience, transportation providers may seek to ensure that the in-transit communication service is delivered to passengers at least with a desired level of availability (e.g., with little to no network downtime or other experienced losses of service), at a desired data rate (e.g., a desired throughput, bandwidth, latency, etc.), and with a desired level of accessibility (e.g., appropriate pricing, support for different applications and/or device types, etc.). Any or all of these considerations may be reflected in a performance criterion to which the in-transit service performance is compared.

In other arrangements, the in-transit communication service may be provided by a service provider, such as a communication provider (e.g., a satellite communication company), which can provide and operate some or all components of a provider network through which the in-transit service (e.g., in-transit communication service) is provided. Sometimes, the service provider is wholly or partially affiliated with the transportation provider. In other cases, the service provider is separate from the transportation provider. In turn, a transportation provider can ensure a desirable passenger experience through contractual relationships with the service provider. For example, such contractual relationships may define performance standards through service level agreement (SLA) performance metrics, which may comprise, or provide the basis for, a performance criterion.

A passenger may gain access to an in-transit service upon purchase of the service. The purchase of access to an in-transit service may include purchasing an upgraded service experience relative to a lesser (e.g., free) level of service, or purchase of the service may be required to access any portion of the in-transit service. Furthermore, purchasing the in-transit service may enable access for a passenger to an in-seat media player device or access to the in-transit service via the passenger's own personal electronic device that has been brought onboard the transport craft. In any regard, the passenger may purchase the in-transit service through a service provider, a transportation provider, or another entity that processes the payment for the service. As such, in the event of a refund, the payment processor should be notified to allow for processing the refund promptly (e.g., before the completion of the trip).

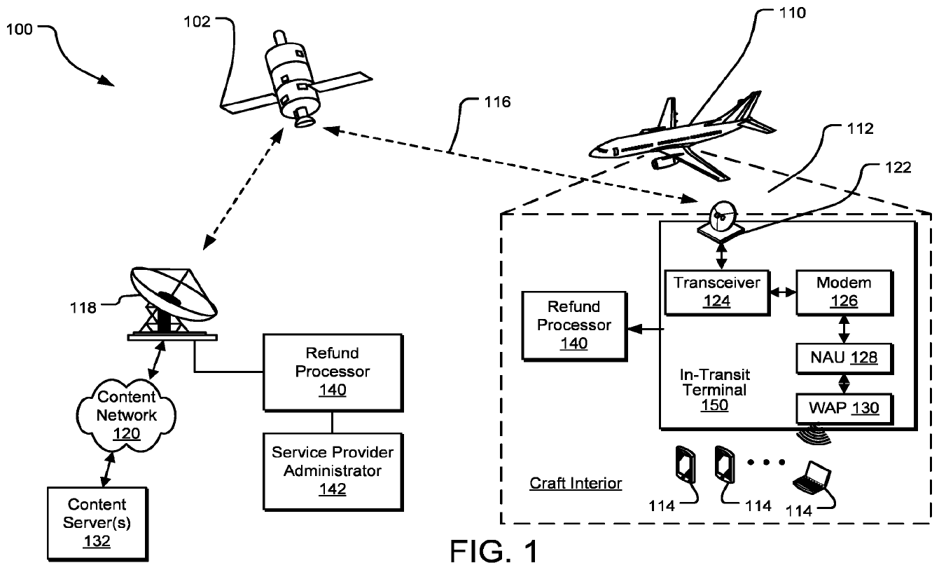

FIG. 1 shows a simplified diagram of a satellite communication system 100, which provides a context for various embodiments described herein. The satellite communication system 100 may comprise a provider network through which an in-transit service is provided to content consumption devices 114 onboard a transport craft 110. For example, the in-transit service may be a data communication service for delivering content from one or more provider-side content sources to the transport craft 110. In addition, the in-transit communication service may include a bidirectional data exchange between a passenger device and a location remote from the transport craft 110. For example, a passenger aircraft can have an onboard system to provide one or more in-transit communication service (e.g., in-flight entertainment, in-flight Internet connectivity, etc.) to passengers via in-seat devices, personal electronic devices, or another appropriate computing device. While the transport craft 110 is in flight, its onboard system can communicate with one or more carriers of the satellite communication system 100, by which the in-transit communication service can be delivered to the passengers. It may be appreciated that the approach described herein may be provided for a single in-transit service or may be used for any one or more of a plurality of in-transit services provided for a trip. Furthermore, while discussed here in the context of providing a refund for in-transit service, the approaches described herein may be generally applied for any purchased service that is provided for a set or estimated duration with an expectation to satisfy a performance criterion.

The satellite communication system 100 may include a service provider administrator 142 that may process payment for access to the in-transit service on the transport craft 110. As noted above, the service provider administrator 142 may be operated by the transport provider (e.g., airline), a service provider (e.g., a satellite communication company) separate from the transport provider, or a third-party payment processor. In any regard, the service provider administrator 142 may include payment processing facilities that allow a passenger to purchase access to the in-transit service. Upon purchasing access to the in-transit service, the infrastructure regarding the satellite communication system 100 described below may provide the purchased in-transit service to the paying passenger.

As used herein, the provider network can include some or all of the provider-side components and craft-side components to communicatively couple the provider-side components with the craft-side components. The provider-side components can include a gateway 118. The provider-side components may also include a refund processor 140. The refund processor 140 may be used to process a refund for the purchased in-transit service or to communicate a notice of a refund for the purchased in-transit service to the service provider administrator 142. As described below, the refund processor 140 may be located on either or both of the provider-side and craft-side. In this regard, one or both of the provider-side or craft-side refund processor 140 may monitor the performance of an in-transport service and project future performance to determine if a performance criterion will be satisfied for the in-transit service. If the refund processor 140 determines that the performance criterion will not be satisfied for a trip of the transport craft 110, the refund processor 140 may trigger a refund for the payment for the service, which may be communicated to the service provider administrator 142.

As noted above and described further below, functionality for the refund processor 140 may be provided from either side of the satellite communication system 100. In some examples, functionality may be provided by both locations of the refund processor 140 operating in parallel. In this regard, each refund processor 140 may provide the entirety of the functions regarding issuing a refund, or portions of the functions may be divided. For instance, different actions may be taken by each refund processor 140 in response to a determination that a refund should be issued. As such, while shown in both a provider-side and craft-side location, a single refund processor 140 in either depicted location may be provided to perform the functionality described herein.

The craft-side components can include an onboard communication system 112, which can have an in-transit terminal 150 with any other suitable communication-related components disposed on the transport craft 110. The provider network can include communication links (e.g., satellite communication links), relays (e.g., satellite 102), and/or any other suitable components disposed between the transport craft and the provider-side components.

The provider-side components may also include one or more content network 120, one or more content server 132, and/or any other suitable components disposed remotely from the transport craft 110, such as network core nodes or the like. The illustrated embodiment shows a transport craft 110 in communication with one or more content server 132 via a satellite 102, a gateway 118, and a content network 120. While the communication system 100 is illustrated with the transport craft 110 as a single aircraft in communication with the satellite 102 via a spot beam 116, such illustration is not intended to be limiting, and embodiments can operate in many different contexts. For example, the communication system 100 can include a plurality of transport craft (e.g., airplanes, trains, buses, blimps, cruise ships, etc.) communicating via any one or more suitable communication architecture(s), including any suitable communication links, such as satellite communication systems, air-to-ground communication systems, hybrid satellite and air-to-ground communication systems, cellular communication systems, etc.

Typically, the mobile nature of the transport craft 110 results in the communication architecture involving at least one wireless communication link. In some embodiments, the transport craft 110 may utilize multiple carriers of the satellite communication system 100. The term “carrier” is used generally to include a wireless communication link by which one or more transport craft 110 and/or content consumption devices 114 can be serviced, such as a spot beam 116 of a satellite communication system (e.g., servicing a particular spot beam coverage area), a particular carrier frequency band and/or polarization within a spot beam of a satellite communication system (e.g., servicing some or all terminals in a particular spot beam coverage area), a cellular carrier frequency band (e.g., servicing cellular terminals in a particular cell coverage area), etc. For example, communication with a particular carrier can involve communicating over a respective wireless link using a particular frequency, polarization, etc. The communication system architecture can use multiple carriers to provide various features, including servicing a large service area comprising multiple carrier coverage areas (e.g., spot beam coverage areas, cell coverage areas, etc.). Carrier coverage areas can partially or fully overlap, so that certain geographic regions are serviced (e.g., concurrently) by multiple carriers. As the transport craft 110 moves through the communication network, it can move through multiple carrier coverage areas, so communication service can be provided to the transport craft 110 via different carriers over time. For example, during a transatlantic or international flight, an airplane, and the content consumption devices 114 of passengers on the airplane, may move through a number of carrier coverage areas. The different carriers servicing those coverage areas can be used over time to maintain communication with the transport craft 110 over a large geographic region covered during transport (e.g., the traversed region is larger than a single carrier coverage area), and/or to provide other features, such as facilitating load balancing across multiple carriers, grouping of terminals by carrier, etc. Moving a transport craft 110 from one carrier to another carrier during transport can involve “handover” of communication services between those carriers, which can involve handing over pending multicast communication and/or other services in some cases.

Use of the in-transit communication service by passengers of the transport craft 110 can involve communication of various types of content over the provider network. For example, the content can include media content streaming (e.g., over-the-top television, movie, or radio programming); live television or radio viewing; Internet browsing, social media, or online gaming interactions; emailing, texting, or other messaging interactions; etc. Such content can originate from, and/or be destined for, the one or more content server 132 via the content network 120 and gateway 118 (and/or other provider-side network nodes). The content network 120 can include any suitable type of network, such as the Internet, an IP network, an intranet, a wide area network (WAN), local area network (LAN), a virtual private network (VPN), a virtual LAN (VLAN), a fiber optic network, a cable network, a public switched telephone network (PSTN), a public switched data network (PSDN), a public land mobile network, and/or any other type of network supporting communication as described herein. The content network 120 can include both wired and wireless connections as well as optical links.

The one or more content server 132 can be accessible via the satellite 102 in any suitable architecture. For example, content can be generated by the one or more content server 132, stored at the one or more content server 132, and/or received by the one or more content server 132 via content network 120. The one or more content server 132 may be located at the gateway 118, core node, or any other suitable location of the communication infrastructure. The content can be communicated from the one or more content server 132 to the content consumption devices 114 (e.g., in response to requests for such media from the content consumption devices 114) while in flight, via the satellite 102 and the onboard communication system 112. Although only one content server is shown to avoid over-complication of the drawing, the content received by the content consumption devices 114 may be from the one or more content server 132 in one or more locations. In some cases, the provision of an in-transit communication service involves providing content in response to requests (e.g., explicit or implicit requests) for such content from the content consumption devices 114. In other cases, the provision of the in-transit communication service involves pushing the content to the transport craft 110 and/or to particular content consumption devices 114 not in response to a client request. For example, content can be pushed to content consumption devices 114 based on a schedule or for pre-positioning purposes, content can be broadcast or multicast to the transport craft 110 using any suitable communication protocols and/or schema, etc.

Provision of the in-transit communication service to the transport craft 110 can involve interactions between the provider-side components of the network and the onboard communication system 112 (e.g., via one or more satellite communication links such as a spot beam 116 and the satellite 102). Embodiments of the onboard communication system 112 include the in-transit terminal 150, and the in-transit terminal 150 can include an antenna system 122, transceiver 124, modem 126, network access unit 128, and wireless access point 130. In some implementations, the onboard communication system 112 can provide for the reception of a forward downlink signal from the satellite 102 and transmission of a return uplink signal to the satellite 102 to support two-way data communication between content consumption devices 114 within the transport craft 110 and provider-side components of the provider network. The content consumption devices 114 can include mobile devices (e.g., smartphones, laptops, tablets, netbooks, and the like) that may comprise personal electronic devices (PEDs) brought onto the transport craft 110 by passengers, flight crew, etc. As further examples, the content consumption devices 114 can include in-seat or passenger seat back systems, or other devices on the transport craft 110. The content consumption devices 114 can communicate with the network access unit 128 via a communication link that can be wired and/or wireless. The communication link can be, for example, part of a local area network, such as a wireless local area network (WLAN) supported by wireless access point 130. One or more wireless access point 130 can be distributed about the transport craft 110, and can, in conjunction with network access unit 128, provide traffic switching and routing functionality; for example, as part of a WLAN extended service set (ESS), etc.

In operation, the network access unit 128 can provide uplink data received from the content consumption devices 114 to the modem 126 to generate modulated uplink data (e.g., a transmit intermediate frequency (IF) signal) for delivery to the transceiver 124. The transceiver 124 can upconvert and then amplify the modulated uplink data to generate the return uplink signal for transmission to the satellite 102 via the antenna system 122. Similarly, the transceiver 124 can receive the forward downlink signal from the satellite 102 via the antenna system 122. The transceiver 124 can amplify and downconvert the forward downlink signal to generate modulated downlink data (e.g., a receive IF signal) for demodulation by the modem 126. The demodulated downlink data from the modem 126 can be provided to the network access unit 128 for routing to the content consumption devices 114. The modem 126 can be integrated with the network access unit 128 or can be a separate component in some examples.

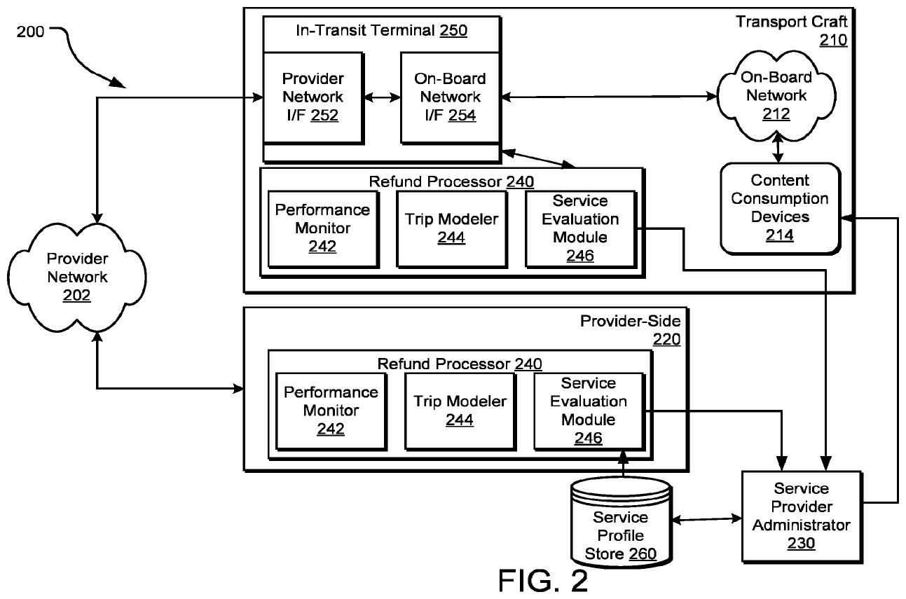

With further reference to FIG. 2, an example of a communication system 200 shows example craft-side components onboard a transport craft 210 and provider-side components on the provider-side 220 of a provider network 202. The transport craft 210 may include an in-transit terminal 250. The in-transit terminal 250 may be in communication with a number of content consumption devices 214 over an on-board network 212. The in-transit terminal 250 can include a provider network interface 252 to communicatively couple with the provider network 202 over which the in-transit communications service is provided to the transport craft 110. The in-transit terminal 250 may also include an on-board network interface 254 to communicatively couple with the content consumption devices 214 via the on-board network 212.

The transport craft 210 may also include a refund processor 240. The refund processor 240 may include a number of components used for projecting in-transit service performance for determining whether to issue a refund during a trip of the transport craft 210. The refund processor 240 may include a performance monitor 242, a trip modeler 244, and a service evaluation module 246. The refund processor 240 may generally be in communication with the in-transit terminal 250 to monitor the performance of the provider network interface 252 and the on-board network interface 254.

In any regard, the performance monitor 242 may include measurement capability to monitor the in-transit terminal 250 and/or aspects thereof. Such measurement capability may comprise network testing functionality for determining performance parameters regarding the functions of the in-transit terminal 250 in providing the in-transit communication service. In this regard, the performance monitor 242 may be operative to monitor the actual performance of the in-transit terminal 250 when providing the in-transit service to the content consumption devices 214. The actual performance of the in-transit service provided by the in-transit terminal 250 may be monitored for an elapsed portion of a trip of transport craft. The performance monitor 242 may log or otherwise store the actual performance data for the in-transit service locally or communicate it to the provider-side.

The elapsed portion of the trip may be measured from service commencement to the present time during a trip. That is, the in-transit service may be available in a service period that may or may not coincide with the entirety of the trip. Accordingly, as described herein, an elapsed portion and a remaining portion of a trip may correspond to an elapsed portion of a service period and a remaining portion of a service period in which the service is to be provided. For example, service commencement may occur at initial boarding of the transport craft 210, closure of the boarding door of the transport craft 210, departure of the transport craft 210 from a gate (e.g., pushback) or location, occurrence of an event of the transport craft 210 (e.g., weight-off-wheels), positioning of the transport craft 210 relative to a threshold (e.g., ascent through 10,000 feet in altitude), or other time. The determination of service commencement may be defined in contractual agreements between a transport operator and service provider and/or be affected by governmental or airline regulations. In any regard, once the service commencement occurs, the performance monitor 242 may begin to monitor and record the performance of the in-transit terminal 250 in providing the in-transit service in an elapsed portion of the trip since service commencement.

The performance of the in-transit terminal 250 may be characterized by one or more performance parameters. Examples of service parameters may include service availability (e.g., within the service period, omitting any known out of service areas for which the obligation to provide the in-transit service may be waived), bandwidth, throughput, latency, jitter, packet loss, etc. In some examples, the performance monitor 242 may monitor more than one service parameter of the in-transit service. In this case, each parameter may be individually monitored in determining whether to issue a refund or a plurality of parameters may be aggregated into a performance metric. In any regard, the performance monitor 242 may generate a performance metric that describes the quality of the in-transit service that has actually been provided during the elapsed portion of the trip. The performance metric may comprise an average of the one or more service parameters monitored by the performance monitor 242. In this regard, the performance metric may be a single parameter or may comprise an aggregate of a plurality of parameters. In some examples, the performance metric may reflect a quality of experience (QoE) of the paying passengers such that multiple parameters may be combined in a weighted algorithm or otherwise aggregated to generate a performance metric reflective of the QoE.

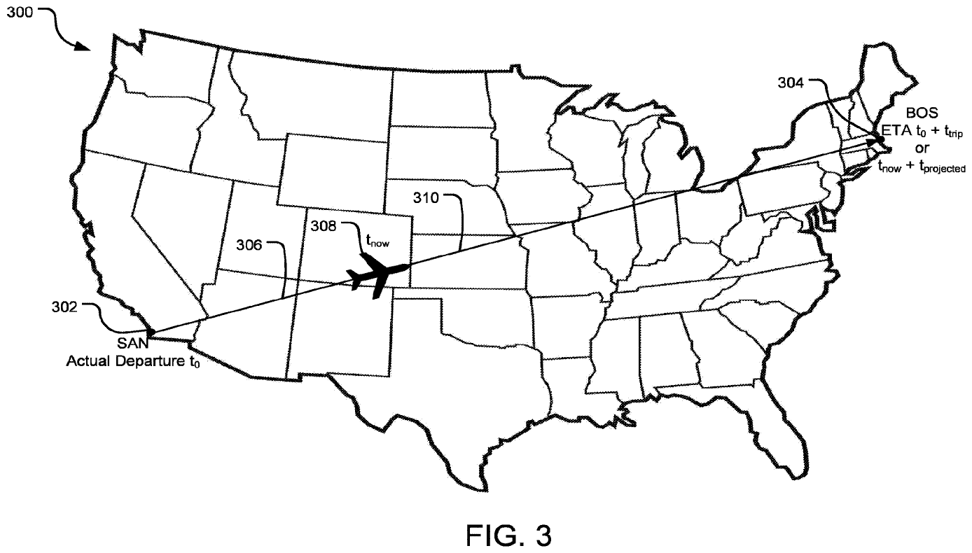

The trip modeler 244 of the refund processor 240 may be used during a trip to generate projected values for a remaining portion of the trip. As noted above, the remaining portion of the trip may comprise a remaining portion of a service period in which the in-transit service is to be provided. As may be appreciated, there may be a number of variables that may affect the determination of the remaining portion of the trip. For example, the remaining portion of the trip may be based on a projected trip duration. With further reference to FIG. 3, an example of a trip 300 is illustrated. The trip 300 includes an origin 302 of San Diego, CA and a destination 304 of Boston, MA. An elapsed flight path 306 is depicted from the origin 302 to a current location 308 of a transport craft. The performance monitor 242 may monitor the performance of the in-flight service that has occurred between the origin 302 and the current location 308 along the elapsed flight path 306.

A projected flight path 310 from the current location 308 to the destination 304 is also shown. As may be appreciated the projected flight path 310 may be used to determine a projected trip duration by estimating a remaining portion of the trip. Any one of a number of approaches may be used to determine the duration of a remaining portion of the trip. For example, the remaining duration may be based on a published estimated time of arrival (e.g. provided by the transport operator). In another example, an estimated time of arrival may be determined using an actual departure time t₀ from the destination 304 with a calculated trip duration tₜᵣᵢₚ added to the departure time t₀. The calculated tₜᵣᵢₚ duration ttrip may be based on the historical performance of trips between the origin 302 and the destination 304 or a published trip duration value provided by a transport operator. In other approaches, the remaining trip duration may be determined based on the current time t_{now} at the current location 308, with a remaining transit time t_{projected} being determined based on projected transport craft speed and trajectory (e.g., based on the projected flight path 310, which may be affected by traffic routing, weather, delays, etc.). In any regard, the trip modeler 244 may determine a projected trip duration that includes the elapsed portion of the trip and the remaining duration of the trip, regardless of how the remaining duration of the trip is determined.

Furthermore, as described regarding a service period, service termination may correspond to a specified event during the trip. Thus, the remaining portion of the trip may be determined to service termination, which may correspond to, for example, the opening of the boarding door of the transport craft 210 at the arrival gate or location, arrival of the transport craft 210 to a gate or location, occurrence of an event of the transport craft 210 (e.g., weight-on-wheels), the position of the transport craft 210 relative to a threshold (e.g., decent through 10,000 feet in altitude), or other time. The determination of service termination may be defined in contractual agreements with a transport operator and/or be affected by governmental or airline regulations.

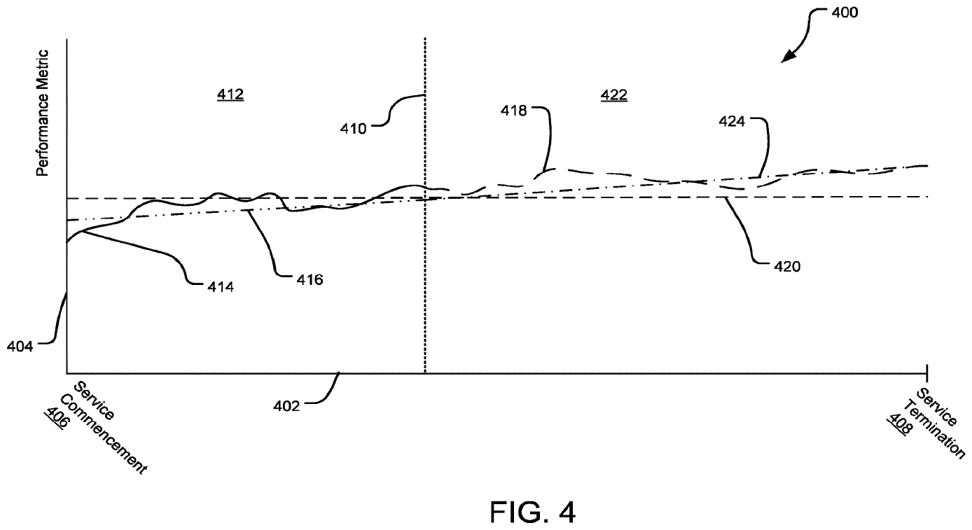

The trip modeler 244 may also project a future performance of the in-transit service for the remaining portion of the trip. The future performance of the in-transit service may include any appropriate approach, examples of which are described below in relation to FIGS. 4-6. In any regard, the trip modeler 244 may generate a total trip performance metric for the in-transit service. The total trip performance metric may include the actual performance of the in-transit service measured by the performance monitor 242 for the given current location 308 of the transport craft 210 and the future performance projected or estimated by the trip modeler 244. Furthermore, the total trip performance metric may be an average of the actual performance and the projected performance of the projected trip duration.

In any regard, the trip modeler 244 may communicate the total trip performance metric to the service evaluation module 246. The service evaluation module 246 may obtain a performance criterion from a service profile store 260. The service profile store 260 may be populated with the performance criterion by a service provider administrator 230, which, as noted above, can be a transport operator, service operator, or other entity. As previously described, the performance criterion may be defined by the transport operator, service operator, or other entity. In an example, the performance criterion may be defined by service level agreements (SLAs) defined by contractual obligations between a transport operator and a service operator. An SLA may provide a performance standard comprising or on which the performance criterion is based.

In any regard, the service evaluation module 246 may compare the total trip performance metric received from the trip modeler 244 to the performance criterion. The performance criterion may include a minimum threshold, maximum threshold, acceptable range, or other defined requirements for the total trip performance metric. For example, a bandwidth parameter may be required to exceed some minimum threshold to satisfy the performance criterion. Additionally or alternatively, a latency parameter may be required to fall below some maximum threshold to satisfy the performance criterion. In this regard, while described as a performance criterion, it may be appreciated that the performance criterion may comprise a plurality of criteria that must be satisfied by one or more of the performance parameters of the in-transit service.

If the service evaluation module 246 determines that the total trip performance metric does not satisfy the performance criterion, the service evaluation module 246 may generate a refund for the payment for the in-transit service. Generating the refund by the service evaluation module 246 may include generating a notification that a refund should be issued, which is communicated to the service provider administrator 230. As the service provider administrator 230 may comprise the entity processing payment for the in-transit service, the service provider administrator 230 may issue the refund. Various approaches may be used to communicate a notice to issue a refund from the refund processor 240 to the service provider administrator 230. For example, a direct communication may be made from the refund processor 240 to the service provider administrator 230. Alternatively, a digest file (e.g., an XML file that follows a defined schema) may be saved by the refund processor 240 for access by the service provider administrator 230. The digest file may include identifying information regarding the trip, including a trip identifier (e.g., a flight number), a transport craft identifier (e.g., an aircraft tail number), the origin of the trip, the destination of the trip, time stamps for trip events (e.g., gate pushback, weight off wheels, ascent through 10,000 feet, etc.), and an estimated time of arrival. In turn, the service provider administrator 230 may retrieve the digest file and process the refund using the information identified therein. In other examples, the refund processor 240 may include an application programming interface (API) that pushes refund notices to the service provider administrator 230 or allows the service provider administrator 230 to periodically request updates on any issued refunds. The information from the digest file may be provided via such an API. In still other examples, the refund processor 240 may be operated by the same payment provider that processed a purchase and, therefore, may issue a refund directly.

As the total trip performance metric is generated during a trip of the transport craft 210 between the origin 302 and the destination 304, determining if the total trip performance metric satisfies the performance criterion may also be performed during the trip. That is, the approach in which a projected trip duration and a projected future performance of an in-transit service is determined may allow for a refund to be issued during a trip of a transport craft 210 such that paying passengers may be issued a refund prior to arrival at the destination 304. Further still, a refund may be issued without paying passengers requesting a refund. This approach may alleviate the need for a passenger to interact with customer support, thereby reducing the contact volume to customer service, which may provide an enhanced user experience to the passengers.

In other examples, a message may be provided from a refund processor 240 (e.g., a refund processor 240 onboard the transport craft 210 or on the provider-side 220) to the in-transit terminal 250. In this case, the in-transit terminal 250 may update offerings to the passengers based on a refund notification. For example, upon receipt of a notice that a refund will be issued, the in-transit terminal 250 may disable or preclude further purchases of the in-transit service. Additionally or alternatively, the in-transit terminal 250 could take other actions such as enabling access to the in-transit service to all passengers, switching to an onboard content library for presentation, reducing pricing, providing notification of the rebate issues to previous purchasers, etc. Further still, a notification could be provided to passengers wishing to purchase services that the in-transit services are experiencing degraded performance. This could be coupled with a discount on such services. Additionally or alternatively, passengers purchasing in-transit services after such a notification is provided may not be eligible for a refund.

In this regard, receipt of a notice that a refund is to be issued does not require issuance of a refund to all passengers or all paying passengers. For example, a portion of paying passengers who purchased a different service level may be issued a refund. Moreover, the nature of the level of service may affect the issuance of refunds. As an example, specific performance metrics may fail to meet a given performance criterion. Customers affected by the specific performance metric may be refunded upon determining that the performance metric will fail to meet the performance criterion. As an example, a deficiency in latency may affect passengers using real-time communications, such as voice or video calls, but may not affect passengers streaming content. In this regard, if a latency-related performance metric fails to meet a performance criterion, passengers having utilized real-time communications such as voice or video calls may be issued a refund, whereas passengers having only streamed content may not be issued a refund. In this regard, the message regarding the refund may be specific to service utilization such that only affected passengers using a specific aspect of the service may be issued a refund. In addition, individual passenger usage may be otherwise considered in determining whether a refund is to be issued. For example, a given user may exceed a threshold for service usage (e.g., by exceeding a bandwidth usage threshold or the like). Such a passenger may not be eligible for a refund in the event of the total trip performance metric not satisfying the performance criterion. Furthermore, an individual user may experience service degradation resulting from a technical issue with their device. In this case, a specific passenger may not be issued a refund if their usage is anomalous in a manner that indicates the user's device is the source of the degradation. For example, a usage that deviates from the overall flight performance metric of other devices onboard the transport craft may indicate that a technical issue is specific to a given user's device rather than the performance of the in-transit service.

As shown in FIG. 2, the provider-side 220 may also include a refund processor 240. In this regard, all the foregoing functionality of the refund processor 240 described in relation to the refund processor 240 located at the transport craft 210 is equally applicable to the refund processor 240 at the provider-side 220. For instance, the refund processor 240 located at the provider-side 220 may communicate with the in-transit terminal 250 to measure actual performance for use in determining if a refund should be issued. Other craft-to-provider-side communications may also be effectuated to achieve the functionality described above.

Furthermore, the refund processor 240 may comprise a computing device or a computer-based module operating on the in-transit terminal 250 or at the provider-side 220. As such, the refund processor 240 may be executed using a hardware processor that accesses stored machine-readable instructions from memory for performing the functionality described herein, including that of the performance monitor 242, trip modeler 244, and/or service evaluation module 246. Accordingly, the refund processor 240 may comprises hardware and/or software embodied by instructions stored in the memory and/or storage devices accessible and executable by the processor. Additionally or alternatively, the refund processor 240 may comprise one or more field programmable gate arrays (FGPAs), application-specific integrated circuits (ASIC), or other hardware/software/firmware capable of providing the functionality described herein.

FIGS. 4-6 illustrate various examples in which a total trip performance is generated and used to determine, during a trip, if the total trip performance satisfies a performance criterion. FIG. 4 illustrates a performance chart 400 for a given trip. The performance chart 400 includes a time axis 402 extending from service commencement 406 to service termination 408. A current time 410 is depicted as a vertical line with an elapsed portion 412 of a trip represented to the left of the current time 410 and a remaining portion 422 of the trip represented to the right of the current time 410.

The elapsed portion 412 includes actual performance 414 of the in-transit service plotted on a performance metric axis 404. Also, a performance criterion 420 for the trip is illustrated. As noted above, the actual performance 414 may be representative of a performance metric that may be a single in-transit service parameter or may be an aggregation of a plurality of in-transit service parameters.

In the example depicted in the performance chart 400, the actual performance 414 may be used to extrapolate the actual performance for the remaining portion 422. In this regard, an average 416 based on the actual performance 414 may be generated and used to extrapolate future performance 418 for the remaining portion 422. In turn, the actual performance 414 and the future performance 418 may be used to generate a total trip performance metric 424, which may include a projection of the performance of the service as predicted to occur over the total trip. As can be seen in FIG. 4, the total trip performance metric 424 at the current time 410 is projected to satisfy performance criterion 420 (e.g., meet or exceed) the at termination 408 such that no refund is issued at the current time 410. If, at a future time beyond the current time 410, the total trip performance metric 424 indicates the performance of the in-transit service will not satisfy the performance criterion 420 (e.g., the total trip performance metric 424 falls below the performance criterion 420 in the depicted example), a refund may be issued.

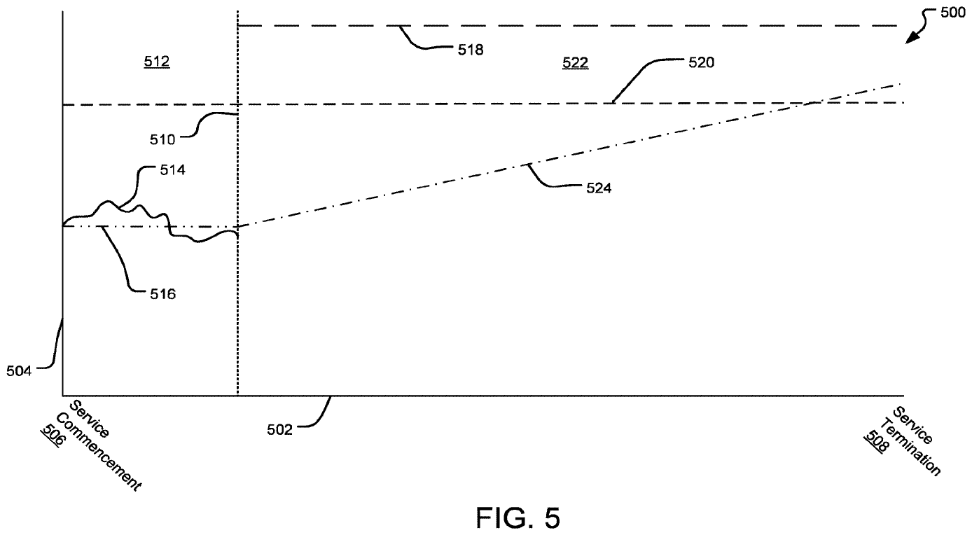

FIG. 5 depicts an example performance chart 500 using a different approach to projecting future performance than shown in FIG. 4. In FIG. 5, similar reference labels are used as those described above in FIG. 4. That is, the performance chart 500 includes a time axis 502 depicting a time between a service commencement 506 and service termination 508 and a performance metric axis 504. Actual performance 514 for an elapsed portion 512 is shown to the right of a current time 510. A performance criterion 520 is represented in the performance chart 500.

However, in FIG. 5, rather than extrapolating the actual performance 514 into a remaining portion 522, the performance chart 500 may project a selected or presumed performance 518. The selected performance 518 may be any assigned performance that is projected into the future (e.g., as opposed to extrapolating actual performance). In one scenario, the selected performance 518 represents an ideal performance of the in-transit service. In other examples, the selected performance 518 may be any selected value or performance profile (which may vary the projected level of performance over the remaining portion 522). In relation to a selected performance 518 value, the selected performance 518 value may be some portion of an ideal performance (e.g., 90% of ideal performance, 80% of ideal performance, 70% of ideal performance, etc.). In other examples, the selected performance 518 value for the selected performance 518 may be an average historical performance for the transport craft, the route, or some other appropriate performance average. Furthermore, if the selected value comprises a performance profile (e.g., that varies over the remaining portion 522), the defined performance profile may be based on the historical performance of the service for a given trip, which may reflect relative increases and decreases in projected performance for the remaining portion 522. In other examples, the selected performance 518 may reflect real time forecasts of service performance (e.g., based on current network conditions that may affect future performance). For instance, if a known issue exists with a carrier that will provide the in-transit service later in the remaining portion 522, the performance profile of the selected performance 518 may reflect an anticipated degradation associated with the carrier.

While other selected performance values may be used, the performance chart 500 will be discussed as an example in which the selected performance 518 is an ideal performance of the in-transit service. As such, a total trip performance metric 524 may be generated that is based on the actual performance 514 (e.g., using an average 516 reflecting the performance metric of the actual performance 514 for the elapsed portion 512) and the ideal selected performance 518. In this regard, the total trip performance metric 524 reflects future values of the total trip performance metric 524 in view of the selected performance 518. As can be appreciated, in FIG. 5, for the current time 510, the total trip performance metric 524 satisfies the performance criterion 520 by the service termination 508.

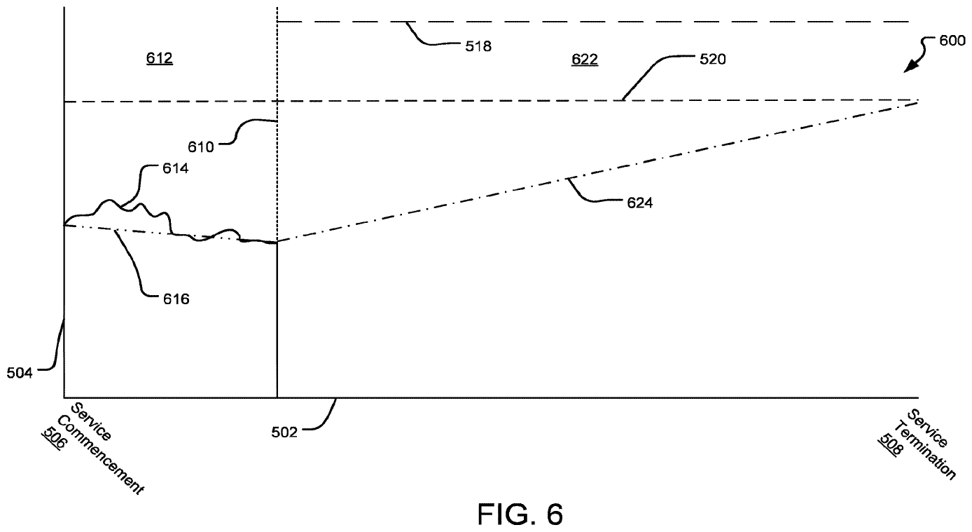

FIG. 6 represents a performance chart 600 corresponding to the performance chart 500 at a current time 610, which is later in the trip than the current time 510 represented in the performance chart 500 of FIG. 5. In FIG. 6, an elapsed portion 612 and a remaining portion 622 are updated to reflect the current time 610. Actual performance 614 is updated to include the additional time between the current time 510 and the current time 610. In this example, because the actual performance 614 deteriorated somewhat, the updated average 616 reflects a degraded actual performance metric as of the current time 610. In this case, even using an ideal selected performance 518, a total trip performance metric 624 based on the updated data projected from the current time 610 does not, and cannot, satisfy the performance criterion 520 by service termination 508 (i.e., the total trip performance metric 624 does not cross the performance criterion 520). The total trip performance metric 624 cannot satisfy the performance criterion 520 as even with ideal performance, the resulting total trip performance metric 624 would not be satisfactory. As such, at the current time 610, a refund would be processed as even ideal future performance of the in-transport service could not allow the total trip performance metric 524 to satisfy the performance criterion 520 by the service termination 508.

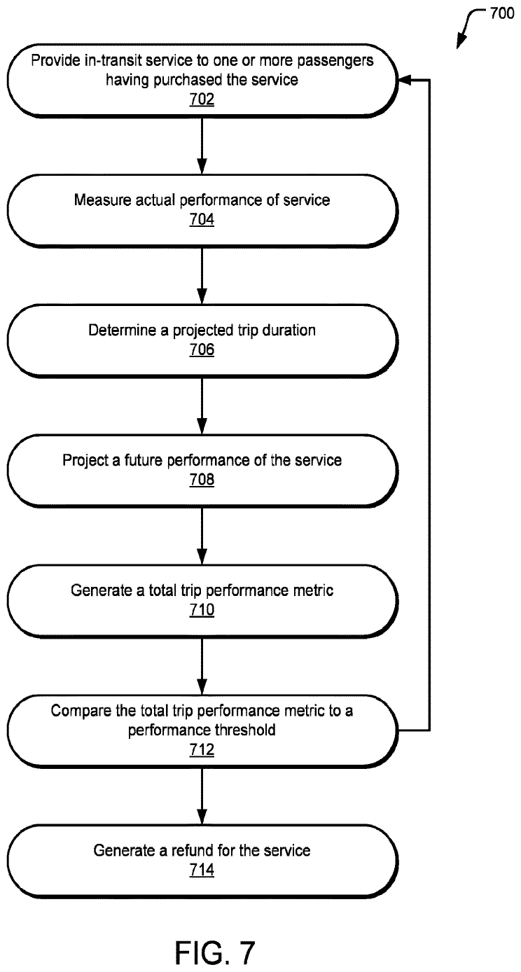

FIG. 7 illustrates an example method 700 for issuing a refund for an in-transit service that is provided during a trip of a transport craft. The method 700 may include a providing operation 702, in which an in-transit service is provided to one or more passengers having purchased the in-transit service. As noted above, the in-transit service may comprise an in-transit data communication service. In this regard, the providing operation 702 may include unidirectional or bidirectional data communication between a content consumption device of a paying passenger onboard the transport craft and a provider-side note, such as a content server or the like.

A measuring operation 704 may be performed, in which actual performance of the in-transit service is measured during an elapsed portion of the trip. The measuring operation 704 may include the measurement of one or more service parameters. The one or more service parameters may characterize the performance of the in-transit service, such as an in-transit communication service. Examples of service parameters may include bandwidth, latency, throughput, jitter, packet loss, or performance parameters. Also described above, individual parameters of the in-transit service may be measured and used as a performance metric for the trip such that the performance parameter may be individually compared as performance metrics to a performance criterion. Alternatively, a performance metric may be an aggregation of a plurality of service parameters to provide a performance metric that may reflect a plurality of parameters (e.g., including a QoE score or other calculated performance parameter).

A determining operation 706 may be used to determine a projected trip duration. As noted above, any one of several approaches may be utilized in the determining operation 706, including the use of an estimated time of arrival provided by a transport provider (e.g., a scheduled time of arrival), a calculation based on a time of departure and an estimated or published trip length, or a real-time projection of a time of arrival based on a projected speed/trajectory of the transport craft from the current time and location of the transport craft. In any regard, the determining operation 706 may be utilized to determine a termination of service according to any of the possibilities described above (noting that termination of service may not coincide with arrival at the destination). In this regard, the determining operation 706 may allow for the determination of a remaining portion of the trip.

A projecting operation 708 may be performed, in which future performance of the in-transit service is projected for the remaining portion of the trip (e.g., as determined in the determining operation 706). Like the actual performance, the projected performance may include one or more parameters of the in-transit service, which may individually comprise a projected future performance metric or which may be aggregated into a projected future performance metric.

The projecting operation 708 may include extrapolation of measured actual performance (e.g., as measured during the measuring operation 704) into the remaining portion of the trip. In other examples, a selected performance may be projected in the remaining portion of the trip. The selected performance may include a static value or a performance profile projected over the remaining portion of the trip. The selected performance may be based on historical information regarding in-transit service performance correlated to the present trip. For example, prior trips over a similar route, similar performance of other transport craft in a fleet, or other information may be used to generate the selected performance.

As discussed above, one specific example of a selected performance may include a selected performance value that reflects an ideal performance of the in-transit service over the remaining portion of the trip. In this regard, an ideal selected performance may represent a “best-case scenario” for the possible performance of the in-transit service for the remaining portion of the trip. As will be appreciated below, using the ideal selected performance may allow for early detection that a performance criterion will not possibly be satisfied such that a refund may be generated in a timely manner, such as during the trip (e.g., before arrival at the destination). That is, use of the ideal selected performance may allow a situation to be identified as soon as possible where, even under ideal performance, a total trip performance metric may not be achieved that satisfies the performance criterion. In this regard, the use of the ideal selected performance may allow for early determination of whether to issue a refund, thus providing enhanced goodwill for passengers who may otherwise become frustrated by in-transit service performance falling below an expected level.

Regardless of how the projected future performance is determined, a generating operation 710 may be performed in which a total trip performance metric may be generated using the measured actual performance from the measuring operation 704 and the projected future performance from the projecting operation 708. In this regard, the total trip performance metric generated in the generating operation 710 may provide a holistic view of the actual and projected in-transit service performance over the course of the trip. In this regard, transient or short-term performance degradations may be smoothed in view of the total performance of the in-transit service reflected by the total for performance metric. In one example, the total performance metric may comprise an average of the actual performance and the projected performance over the total duration of the trip.

A comparing operation 712 may be utilized to compare the total trip performance metric to a performance criterion. The performance criterion may be an internally defined standard of a service provider or may be provided by a third party, such as a transport operator. Specifically, the performance criterion may be defined in a contractual obligation between the service provider and a transport provider that defines minimum service level agreement (SLA) standards for the in-transit service provided on the transport craft. In any regard, the comparing operation 712 may determine whether the total trip performance metric satisfies the performance criterion. If the comparing operation determines that the total trip performance metric satisfies the performance criterion, the method 700 may iterate back to the providing operation 702. In this regard, the method 700 may be performed periodically or continuously during the course of the trip such that in-transit service performance at a given current time may be evaluated to determine whether a refund should be issued.

If the comparing operation 712 determines the total trip performance metric does not satisfy the performance criterion, the method 700 may include a generating operation 714 in which a refund for the in-transit service for paying passengers is generated. As discussed above, the generation of the refund may include both the determination that a refund should be issued as well as communicating that determination (e.g., as a refund notice or the like) to an entity responsible for payment processing. As such, the generating operation 714 may be performed by a service provider to process the refund directly or may be used to communicate a refund notice to a transport provider or other third-party having processed payment from the paying passengers for the in-transit service.

As such, the method 700 may facilitate the advantages noted herein by efficiently and expeditiously determining when a refund for purchased an in-transit service should be issued to paying passengers. This may allow for processing a refund to paying passengers or other remedial action to occur during a trip of the transport craft based on the monitored performance of the equipment and systems providing the in-transit service. Accordingly, customer satisfaction may be improved as such customers may not be required to contact customer service and attempt to obtain a refund. In fact, the ability to issue a refund at a point in a trip before reaching the destination may even alleviate a passenger's concern of contacting customer support in the event of substandard in-transit service performance. As such, the monitoring and projection of the in-transit service provided on the transport craft to determine the technical feasibility of satisfactory performance may provide improved functionality for the equipment providing the in-transit service by allowing equipment of such a communication system to provide an early remedial action that enhances future purchases of the services by paying passengers by fostering an improved customer service experience.

The computing device(s) described herein (e.g., including the refund processor 240) may include a variety of tangible, or non-transitory, processor-readable storage media and intangible, or transitory, processor-readable communication signals. Tangible processor-readable storage can be embodied by any available media that can be accessed by the computing device and includes both volatile and nonvolatile storage media, removable and non-removable storage media. Tangible processor-readable storage media excludes intangible or transitory communications signals and includes volatile and nonvolatile, removable and non-removable storage media implemented in any method or technology for storage of information such as processor-readable instructions, data structures, program modules or other data. Tangible, or non-transitory, processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means an intangible or transitory communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations of computing devices (e.g., the refund processor 240) may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

In some aspects, the techniques described herein relate to a method for refunding a passenger for an in-transit service on a transport craft based on performance of the in-transit service, including: measuring actual performance of the in-transit service provided on the transport craft during an elapsed portion of a trip of the transport craft between an origin and a destination; determining a projected trip duration including the elapsed portion of the trip and a remaining portion of the trip; projecting a future performance of the in-transit service for the remaining portion of the trip; generating a total trip performance metric for the in-transit service based on the actual performance and the future performance; comparing the total trip performance metric to a performance criterion for the trip; and generating a refund for the in-transit service in response to the total trip performance metric not satisfying the performance criterion.

In some aspects, the techniques described herein relate to a method, wherein the generating the refund occurs without the passenger requesting the refund.

In some aspects, the techniques described herein relate to a method, further including: estimating a total trip duration between the origin and the destination, wherein the remaining portion of the trip includes the total trip duration less the elapsed portion of the trip.

In some aspects, the techniques described herein relate to a method, wherein the elapsed portion of the trip and the remaining portion of the trip include a service period in which the in-transit service is offered to the passenger.

In some aspects, the techniques described herein relate to a method, wherein the total trip duration is estimated based on a projected speed and trajectory of the transport craft.

In some aspects, the techniques described herein relate to a method, wherein the total trip duration is estimated based on a scheduled arrival time at the destination.

In some aspects, the techniques described herein relate to a method, wherein the total trip duration is estimated based on historical trip performance for previous instances of the trip.

In some aspects, the techniques described herein relate to a method, wherein the projecting the future performance includes assigning a selected performance of the in-transit service over the remaining portion of the trip.

In some aspects, the techniques described herein relate to a method, wherein the selected performance includes ideal performance of the in-transit service over the remaining portion of the trip.

In some aspects, the techniques described herein relate to a method, further including: determining that the total trip performance metric, based on the ideal performance of the in-transit service, cannot satisfy the performance criterion for the trip prior to arrival of the transport craft at the destination; wherein the generating the refund is in response to the determining that the total trip performance metric cannot satisfy the performance criterion for the trip.

In some aspects, the techniques described herein relate to a method, wherein the projecting the future performance includes extrapolating the actual performance over the remaining portion of the trip.

In some aspects, the techniques described herein relate to a method, wherein the method is performed periodically over the trip.

In some aspects, the techniques described herein relate to a method, wherein the method is performed continuously over the trip.

In some aspects, the techniques described herein relate to a method, wherein the in-transit service includes a data communication service.

In some aspects, the techniques described herein relate to a method, wherein the data communication service include a service level agreement (SLA) performance standard, and wherein the performance criterion relates to the SLA performance standard.

In some aspects, the techniques described herein relate to a method, wherein the SLA performance standard includes one or more of communications availability, latency, or bandwidth.

In some aspects, the techniques described herein relate to a system for refunding a passenger for an in-transit service on a transport craft based on performance of the in-transit service, including: a performance monitor operative to measure actual performance of the in-transit service provided on the transport craft during an elapsed portion of a trip of the transport craft between an origin and a destination; a trip modeler operative to: determine a projected trip duration including the elapsed portion of the trip and a remaining portion of the trip, project a future performance of the in-transit service for the remaining portion of the trip, and generate a total trip performance metric for the in-transit service based on the actual performance and the future performance; and a service evaluation module operative to compare the total trip performance metric to a performance criterion for the trip and generate a refund for the in-transit service in response to the total trip performance metric failing to satisfy the performance criterion.

In some aspects, the techniques described herein relate to a system, wherein the service evaluation module generates the refund occurs without the passenger requesting the refund.

In some aspects, the techniques described herein relate to a system, wherein the trip modeler is further operative to estimate a total trip duration between the origin and the destination, wherein the remaining portion of the trip includes the total trip duration less the elapsed portion of the trip.

In some aspects, the techniques described herein relate to a system, wherein the elapsed portion of the trip and the remaining portion of the trip include a service period in which the in-transit service is offered to the passenger.

In some aspects, the techniques described herein relate to a system, wherein the total trip duration is estimated based on a projected speed and trajectory of the transport craft.

In some aspects, the techniques described herein relate to a system, wherein the total trip duration is estimated based on a scheduled arrival time at the destination.

In some aspects, the techniques described herein relate to a system, wherein the total trip duration is estimated based on historical trip performance for previous instances of the trip.

In some aspects, the techniques described herein relate to a system, wherein the trip modeler is operative assign a selected performance of the in-transit service over the remaining portion of the trip.

In some aspects, the techniques described herein relate to a system, wherein the selected performance includes ideal performance of the in-transit service over the remaining portion of the trip.

In some aspects, the techniques described herein relate to a system, wherein the service evaluation module is further operative to: determine that the total trip performance metric, based on the ideal performance of the in-transit service, cannot satisfy the performance criterion for the trip prior to arrival of the transport craft at the destination; wherein the service evaluation module generates the refund is in response to the determination that the total trip performance metric cannot satisfy the performance criterion for the trip.

In some aspects, the techniques described herein relate to a system, wherein the trip modeler is operative to extrapolate the actual performance over the remaining portion of the trip.

In some aspects, the techniques described herein relate to a system, wherein the in-transit service includes a data communication service.

In some aspects, the techniques described herein relate to a system, wherein the data communication service include a service level agreement (SLA) performance standard, and wherein the performance criterion relates to the SLA performance standard.

In some aspects, the techniques described herein relate to a system, wherein the SLA performance standard includes one or more of communications availability, latency, or bandwidth.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

What is claimed is:

1. A method for refunding a passenger for an in-transit service on a transport craft based on performance of the in-transit service, comprising:
measuring actual performance of the in-transit service provided on the transport craft during an elapsed portion of a trip of the transport craft between an origin and a destination;
determining a projected trip duration comprising the elapsed portion of the trip and a remaining portion of the trip;
projecting a future performance of the in-transit service for the remaining portion of the trip;
generating a total trip performance metric for the in-transit service based on the actual performance and the future performance;
comparing the total trip performance metric to a performance criterion for the trip; and
generating a refund for the in-transit service in response to the total trip performance metric not satisfying the performance criterion.

2. The method of claim 1, wherein the generating the refund occurs without the passenger requesting the refund.

3. The method of claim 1, further comprising:
estimating a total trip duration between the origin and the destination, wherein the remaining portion of the trip comprises the total trip duration less the elapsed portion of the trip.

4. The method of claim 3, wherein the elapsed portion of the trip and the remaining portion of the trip comprise a service period in which the in-transit service is offered to the passenger.

5. The method of claim 3, wherein the total trip duration is estimated based on a projected speed and trajectory of the transport craft.

6. The method of claim 3, wherein the total trip duration is estimated based on a scheduled arrival time at the destination.

7. The method of claim 3, wherein the total trip duration is estimated based on historical trip performance for previous instances of the trip.

8. The method of claim 1, wherein the projecting the future performance comprises assigning a selected performance of the in-transit service over the remaining portion of the trip.

9. The method of claim 8, wherein the selected performance comprises ideal performance of the in-transit service over the remaining portion of the trip.

10. The method of claim 9, further comprising:
determining that the total trip performance metric, based on the ideal performance of the in-transit service, cannot satisfy the performance criterion for the trip prior to arrival of the transport craft at the destination;
wherein the generating the refund is in response to the determining that the total trip performance metric cannot satisfy the performance criterion for the trip.

11. The method of claim 1, wherein the projecting the future performance comprises extrapolating the actual performance over the remaining portion of the trip.

12. The method of claim 1, wherein the method is performed periodically over the trip.

13. The method of claim 1, wherein the method is performed continuously over the trip.

14. The method of claim 1, wherein the in-transit service comprises a data communication service.

15. The method of claim 14, wherein the data communication service comprise a service level agreement (SLA) performance standard, and wherein the performance criterion relates to the SLA performance standard.

16. The method of claim 15, wherein the SLA performance standard comprises one or more of communications availability, latency, or bandwidth.

17. A system for refunding a passenger for an in-transit service on a transport craft based on performance of the in-transit service, comprising:
a performance monitor operative to measure actual performance of the in-transit service provided on the transport craft during an elapsed portion of a trip of the transport craft between an origin and a destination;
a trip modeler operative to:
determine a projected trip duration comprising the elapsed portion of the trip and a remaining portion of the trip,
project a future performance of the in-transit service for the remaining portion of the trip, and
generate a total trip performance metric for the in-transit service based on the actual performance and the future performance; and
a service evaluation module operative to compare the total trip performance metric to a performance criterion for the trip and generate a refund for the in-transit service in response to the total trip performance metric failing to satisfy the performance criterion.

18. The system of claim 17, wherein the service evaluation module generates the refund occurs without the passenger requesting the refund.

19. The system of claim 17, wherein the trip modeler is further operative to estimate a total trip duration between the origin and the destination, wherein the remaining portion of the trip comprises the total trip duration less the elapsed portion of the trip.

20. The system of claim 19, wherein the elapsed portion of the trip and the remaining portion of the trip comprise a service period in which the in-transit service is offered to the passenger.

21. The system of claim 19, wherein the total trip duration is estimated based on a projected speed and trajectory of the transport craft.

22. The system of claim 19, wherein the total trip duration is estimated based on a scheduled arrival time at the destination.

23. The system of claim 19, wherein the total trip duration is estimated based on historical trip performance for previous instances of the trip.

24. The system of claim 17, wherein the trip modeler is operative assign a selected performance of the in-transit service over the remaining portion of the trip.

25. The system of claim 24, wherein the selected performance comprises ideal performance of the in-transit service over the remaining portion of the trip.

26. The system of claim 25, wherein the service evaluation module is further operative to:
determine that the total trip performance metric, based on the ideal performance of the in-transit service, cannot satisfy the performance criterion for the trip prior to arrival of the transport craft at the destination;
wherein the service evaluation module generates the refund is in response to the determination that the total trip performance metric cannot satisfy the performance criterion for the trip.

27. The system of claim 17, wherein the trip modeler is operative to extrapolate the actual performance over the remaining portion of the trip.

28. The system of claim 17, wherein the in-transit service comprises a data communication service.

29. The system of claim 28, wherein the data communication service comprise a service level agreement (SLA) performance standard, and wherein the performance criterion relates to the SLA performance standard.

30. The system of claim 29, wherein the SLA performance standard comprises one or more of communications availability, latency, or bandwidth.
